(19) United States
(12) Patent Application Publication
(10) Pub. No.: US 2010/0223615 A1
(43) Pub. Date: Sep. 2, 2010

(54) Method and apparatus for distributed processing

(76) Inventor: Geoffrey Cross, Oxford (GB)

Correspondence Address: MILAN M. POPOVICH, 53 WESTFIELD ROAD, LEICESTER, ENGLAND, LE3 6HU, GB

(21) Appl. No.: 12/656,646

(22) Filed: Feb. 12, 2010

(30) Foreign Application Priority Data
Feb. 28, 2009 (GB) GB0903510.6

(51) Int. Cl. G06F 9/455; G06F 15/173

(52) U.S. Cl. 718/1; 709/226; 709/217

(57) ABSTRACT

There is provided a distributed data processing system comprising: an application server; and a multiplicity of computers. Each computer has a network connection to the application server and is operative to execute at least one host process. The network connection opens when the computer falls idle. The application server is operative to transmit a VM, a data processing algorithm and data to the computer on detecting an open network connection. The VM is operative to execute a virtual process wherein said data are processed by said algorithm and processed data from the virtual process are transmitted to the server. The network connection is configured to close and the VM is configured so as to be destroyed when a host process interrupts the virtual process.

### REFERENCE TO RELATED APPLICATIONS

This application claims priority to the United Kingdom patent application GB0903510.6 with filing date 28 Feb. 2009 entitled METHOD AND APPARATUS FOR DISTRIBUTED PROCESSING.

### BACKGROUND OF THE INVENTION

The present invention relates generally to the field of data processing and in particular to a method and apparatus for distributed computing.

Distributed computing is a well known process whereby computer programs are divided into components or algorithms that run simultaneously on a multiplicity of computers communicating over a network. Algorithms and data to be processed by the algorithms are distributed to the computers by means of a centralized application server.

Distributed computing processes must overcome the problems of heterogeneous computing environments, network links of varying latencies and unpredictable failures that may occur in the network or the computers. The scale of a network may be limited by the number of and/or cost of computers. A further problem to be overcome is that the algorithms must execute without interrupting the host computer processes or being visible in a way which will disturb the user of the computer.

One well-known solution for overcoming the problem of heterogeneous computing environments is based on the concept of a virtual machine (VM). A virtual machine provide a platform-independent programming environment that abstracts away details of the underlying hardware or operating system, and allows a program to execute in the same way on any platform. A VM is responsible for loading and running an application. An essential characteristic of a VM is that the software running inside is limited to the resources and abstractions provided by the virtual machine. It cannot break out of the virtual world that it creates within the host computer. A well-known example of a VM is the Sun Microsystems' Java runtime environment. A program written in the Java language receives service from the Java Runtime Environment software by issuing commands from which the expected result is returned by the Java software. In this case the Java software acts as a VM by taking the place of the operating system for which the program would ordinarily have had to have been specifically written.

VMs may be classified into two types: system and process VMs. A system virtual machine provides a system platform which supports the operation of a complete operating system. On the other hand a process virtual machine is design to support a single process. In other words a process virtual machine runs one computer program or algorithm.

Personal computers are now ubiquitous and provide processing speeds and memory far in advance of most users needs. Typical user profiles result in computers being lying idle for much of the time, usually overnight or during lunch breaks. This represents a significant amount of underutilized capacity which could be used in a distributed processing system. The concept of using unused CPU processing power for other purposes is exploited in applications such as the System Idle Process used by Windows NT to implement CPU power saving. However, a deterrent to the use of personal computers in distributed processing systems is the reluctance of users to risk computer speed and memory availability being compromised or core processes being slowed down, interrupted or corrupted in some fashion when computers are in use.

There is therefore a need for an efficient and cost-effective distributed processor that delivers algorithms and data to multiple computers communicating over a network, said algorithms and data being confined to a virtual machine that operates only during the times when the computers are idle.

### SUMMARY OF THE INVENTION

It is a first object of the present invention to provide an efficient and cost-effective distributed processor that delivers algorithms and data to multiple computers communicating over a network, said algorithms and data being confined to a virtual machine that operates only during the times when the computers are idle.

In one embodiment of the invention there is provided an apparatus for performing distributed data processing comprising an application server and a multiplicity of computers. Each computer has a network connection to the application server. Each computer has an active state in which it executes at least one host process and an idle state. The network connection opens when the computer falls idle. On detecting that the computer network connection is open the application server transmits a VM, a data processing algorithm and data to the computer. The VM executes a virtual process within the host computer wherein the data are processed by algorithm and the processed data from the virtual process are transmitted to the server. The network connection is configured to close when the virtual process is interrupted by the host process. The VM is integrated within the operating system of the host machine in such a way that it is not noticeable to the operator. The VM only exists between the times when the computer becomes idle and the work states becomes operational.

In one embodiment of the invention the software components for constructing the VM are transmitted to the computer when the connection to the network is opened following an idle state being detected by the application server. The VM is destroyed and the network is closed when the computer re-enters its active state.

In one embodiment of the invention the software components for constructing the VM are transmitted to the computer when the connection to the network is opened following an idle state being detected by the application server. The network is closed when the computer re-enters its active state. However, the VM components are retained for future use.

In one embodiment of the invention the software components for constructing the VM are encoded within the computer, the VM being dormant while the computer is active. The VM is activated when the connection to the network is opened following an idle state being detected by the application server. The VM is deactivated and the network is closed when the computer reenters its active state.

In one embodiment of the invention the VM is distributed to users over the Internet by means of an installer downloaded from a website.

In one embodiment of the invention the operator of the host computer is completely unknown to the server.

Advantageously, the application network and computer are nodes of a data communication network. In one embodiment of the invention the data communication network is provided by the Internet.

In one embodiment of the invention one algorithm is transmitted to each computer.

In one embodiment of the invention the algorithms may comprise sub routines of a computer program.

In one embodiment of the invention the algorithms may be identical and designed for parallel processing by more than one computers.

In one embodiment of the invention the VM is configured as a system virtual machine.

In one embodiment of the invention the VM may access functions and services provided by the computer operating system.

In one embodiment of the invention VM is an as an additional software layer on top of the computer operating system.

In one embodiment of the invention the VM is a software layer that runs on bare hardware.

In one embodiment of the invention a VM be distribute over more one computers working in association.

In one embodiment of the invention the VM may request further data for processing from the application server.

A method of providing distributed processing in accordance with the basic principles of the invention comprises the following steps: providing an application server; providing a data communication network; providing a multiplicity of computers wherein each computer executes at least one host process and each computer has a network connection to the application server; opening said network connection when the computer falls idle; on detecting that the computer network connection is open the application server transmitting a VM, an algorithm and data to the computer; the VM executing a virtual process wherein the data are processed by the algorithm and processed data from are transmitted to the application server; and the network connection closing and the VM being destroyed when the virtual process is interrupted by the host process.

A method of providing distributed processing in accordance with the basic principles of the invention comprises the following steps: providing an application server; providing a data communication network; providing a multiplicity of computers wherein each computer executes at least one host process and each computer has a network connection to the application server; opening the network connection when the computer falls idle; on detecting that the computer network connection is open the application server transmitting a VM, an algorithm and data to the computer; the VM executing a virtual process wherein data are processed by the algorithm and processed data are transmitted to said server; and the network connection closing when the virtual process is interrupted by the host process.

In one embodiment of the invention the application server may have links with external database engines.

In one embodiment of the invention the application server is a computer.

In one embodiment of the invention the application server is hybrid human-computer facility with humans performing the functions of partitioning computer programs and data for distribution to the computers.

A more complete understanding of the invention can be obtained by considering the following detailed description in conjunction with the accompanying drawings wherein like index numerals indicate like parts. For purposes of clarity details relating to technical material that is known in the technical fields related to the invention have not been described in detail.

### BRIEF DESCRIPTION OF THE DRAWINGS

FIG. 1 is a block diagram illustrating one embodiment of the invention.

FIG. 2 is a block diagram illustrating one embodiment of the invention.

FIG. 3 is a block diagram illustrating one embodiment of the invention.

FIG. 4 is a block diagram illustrating one embodiment of the invention.

FIG. 5 is a block diagram illustrating one embodiment of the invention.

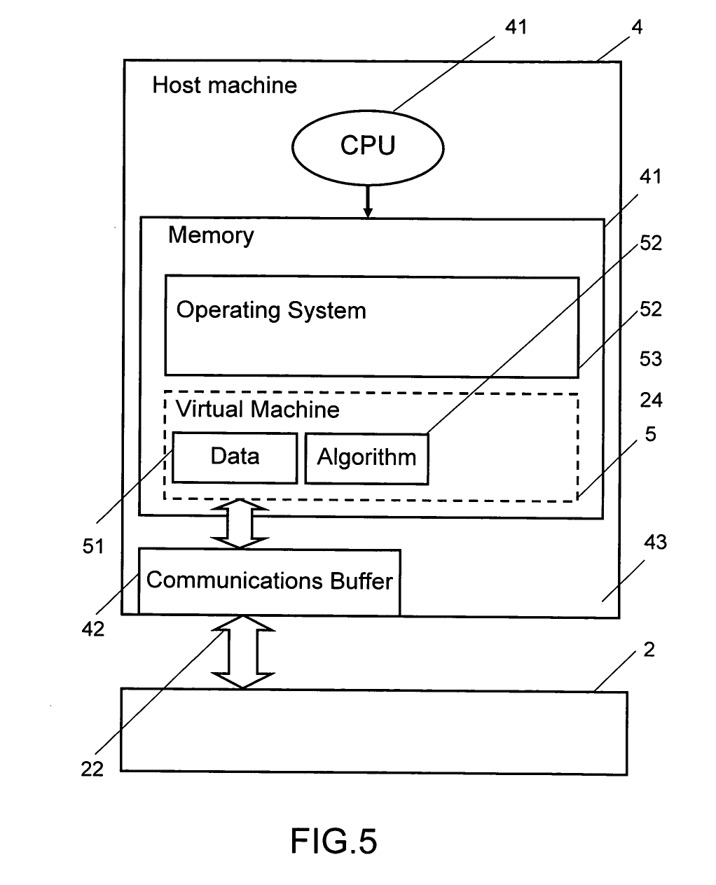

FIG. 6 is a flow diagram illustrating one embodiment of the invention.

FIG. 7 is a flow diagram illustrating one embodiment of the invention.

FIG. 8 is a flow diagram illustrating one embodiment of the invention.

FIG. 9 is a flow diagram illustrating one embodiment of the invention.

FIG. 10 is a flow diagram illustrating one embodiment of the invention.

### DETAILED DESCRIPTION OF THE INVENTION

The aim of the present invention is to provide an efficient and cost-effective method and apparatus for distributed processing that delivers algorithms and data to multiple computers communicating over a network, said algorithms and data being confined to a virtual machine that operates only during the times when the computers are idle.

It will be apparent to those skilled in the art that the present invention may be practiced with only some or all aspects of the present invention as disclosed in the present application. In the following description well-known features of computer systems and computer software have been omitted or simplified in order not to obscure the basic principles of the invention.

Parts of the following description will be presented using terminology commonly employed by those skilled in the art, such as: data, algorithm, database, communications link, server, network, computer and so forth.

For the purpose of explaining the invention certain operations will be described as multiple discrete steps performed in turn. However, the order of description should not be construed as to imply that these operations are necessarily performed in the order they are presented, or order dependent. Indeed certain steps may be performed simultaneously.

For the purposes of explaining the invention the meaning of the term data may be considered to cover images text, numerical and symbols etc. An algorithm may be understood to mean any computable set of steps to achieve a desired result from the data.

It should also be noted that in the following description of the invention repeated usage of the phrases “in one embodiment” or “in certain embodiments” does not necessarily refer to the same embodiment.

The invention provides an apparatus and method for performing distributed data processing comprising an application server and a multiplicity of computers. Each computer has a network connection to the application server. Each computer has an active state in which it executes at least one host process and an idle state. The network connection opens when the computer falls idle. On detecting that the computer network connection is open the application server transmits a VM, a data processing algorithm and data to the computer. The VM executes a virtual process within the host computer wherein the data are processed by algorithm and the processed data from the virtual process are transmitted to the server. The network connection is configured to close when the virtual process is interrupted by the host process. Typically the virtual process will continues until a predetermined result is achieved unless interrupted by the host process. The virtual process will normally occur between predetermined start and end times.

In one embodiment of the invention the operator of the host computer is completely unknown to the server.

In one embodiment of the invention the software components for constructing the VM are transmitted to the computer when the connection to the network is opened following an idle state being detected by the application server. The VM is destroyed and the network is closed when the computer reenters its active state.

In one embodiment of the invention the software components for constructing the VM are transmitted to the computer when the connection to the network is opened following an idle state being detected by the application server. The network is closed when the compute re-enters an active state. However, the VM is retained for future use.

In one embodiment of the invention the software components for constructing the VM are encoded within the computer the VM being dormant while the computer is active. The VM is activated when the connection to the network is opened following an idle state being detected by the application server. The VM is deactivated and the network is closed when the computer reenters an active state.

Advantageously, the application network and computer are nodes of a data communication network. In one embodiment of the invention the data communication network is provided by the Internet with the algorithms and data being delivered using the Hyper Text Transfer Protocol. However, the invention may be applied with any other type of network such as a Local Area Network (LAN) or a Wide Area Network (WAN).

In one embodiment of the invention the VM is distributed to users over the Internet by means of an installer downloaded from a website.

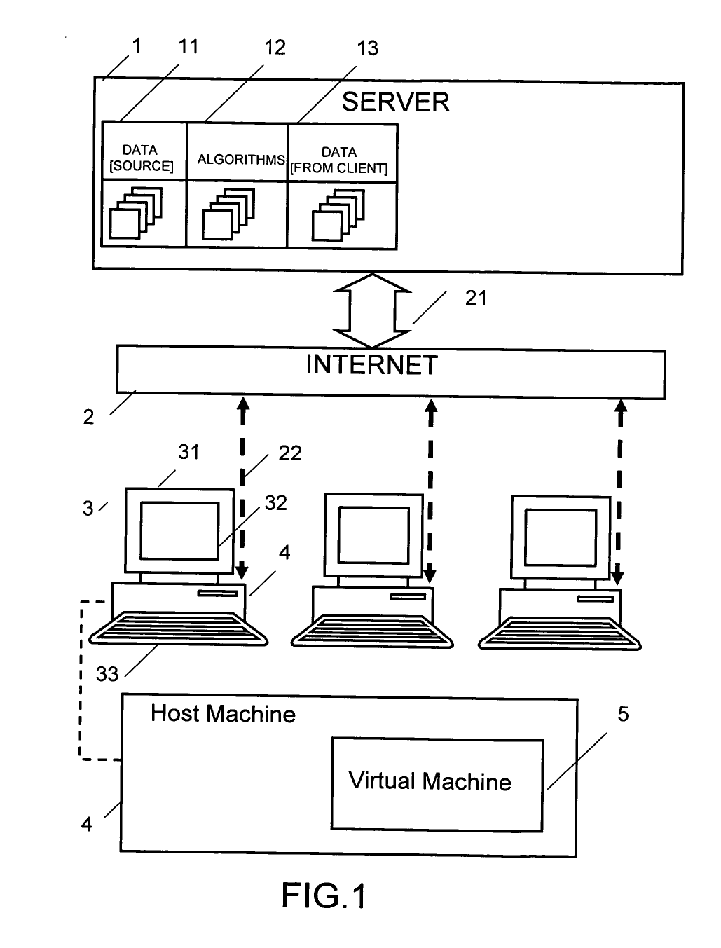

FIG. 1 is a flow diagram illustrating the general principles of one embodiment of the invention. The key entities are the application server 1, data distribution network 2, a multiplicity of computers generally indicated by 3 are connected to the application server via the data distribution network. Each computer provides one node of a network. The application server is a software engine connected to the data distribution network via a data link indicated by 21. The application server provides algorithms 12 and data 11 to be processed by the algorithms. Processed data 13 received from the computers is stored in the application server. The invention does not require the algorithms to be written any particular programming language.

Each computer normally runs a host process typically comprising an application requiring system processor and or memory resources. For example a host process may comprises at least one of user interaction with the computer via a mouse, keyboard or other peripheral device; the execution of a computer program; or the transfer of data via a communications port.

Each computer comprises a display 31 for displaying visual data in a region generally indicated by 32 and a keyboard 33. It should be emphasized that a human computer interface is not required in all embodiments of the invention. The computer further comprises a processor generally indicated by 4. The computer is connected to the data distribution network via a data 20 communications port indicated by 22. The invention does not require that the computers are identical in terms of hardware or operating system

As will be discussed below, the invention relies on building a virtual machine (VM) within the memory of each computer. The VM is integrated within the operating system of the host machine in such a way that it is not noticeable to the operator and requires no intervention by the operator. The VM provides a software platform for the execution of the algorithm provided by the application server. The software running inside the VM does not interfere with the main operations of the physical machine. Moreover, the VM only exists between the times when the computer becomes idle and the work states becomes operational. An operational state is initiated by the resumption of the host process as defined above. At all other times the computer is deemed to be in an idle state.

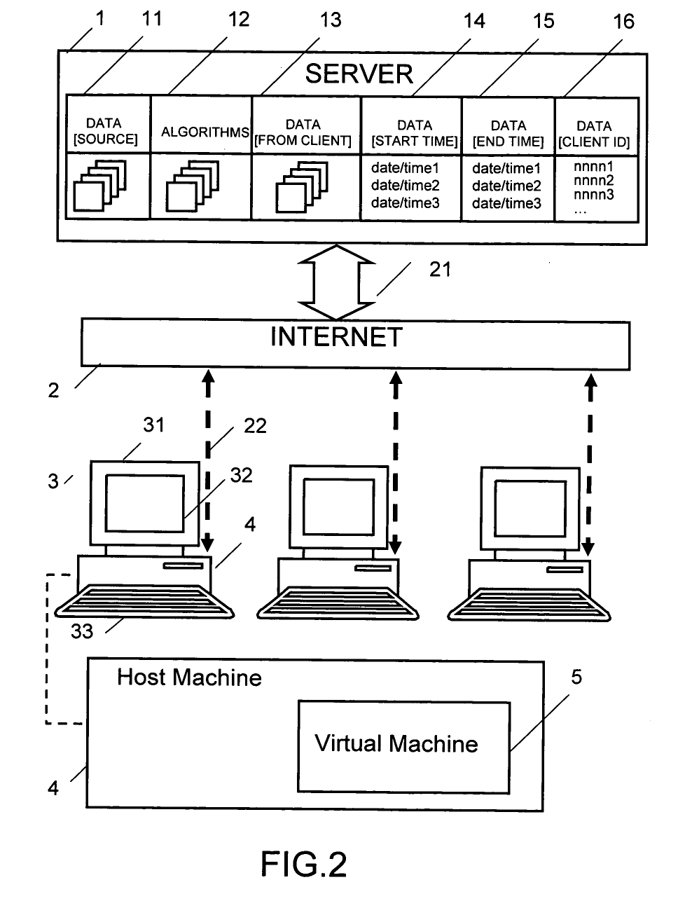

In one embodiment of the invention shown in FIG. 2 the application server further comprises a database for recording the start 14 and end times 15 of each client assignment and identification codes for each client 16.

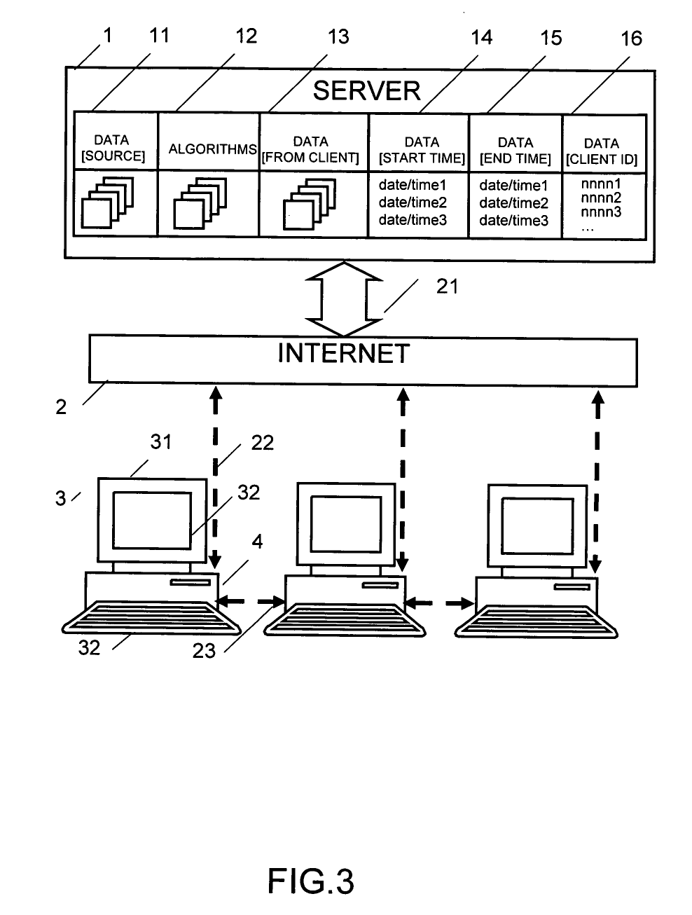

In one embodiment of the invention shown in FIG. 3 two or more computers may exchange processed data via a communication link such as the one indicated by 23. The communication link may be provided by the Internet. Alternatively the communication link may be provided by a LAN or a WAN.

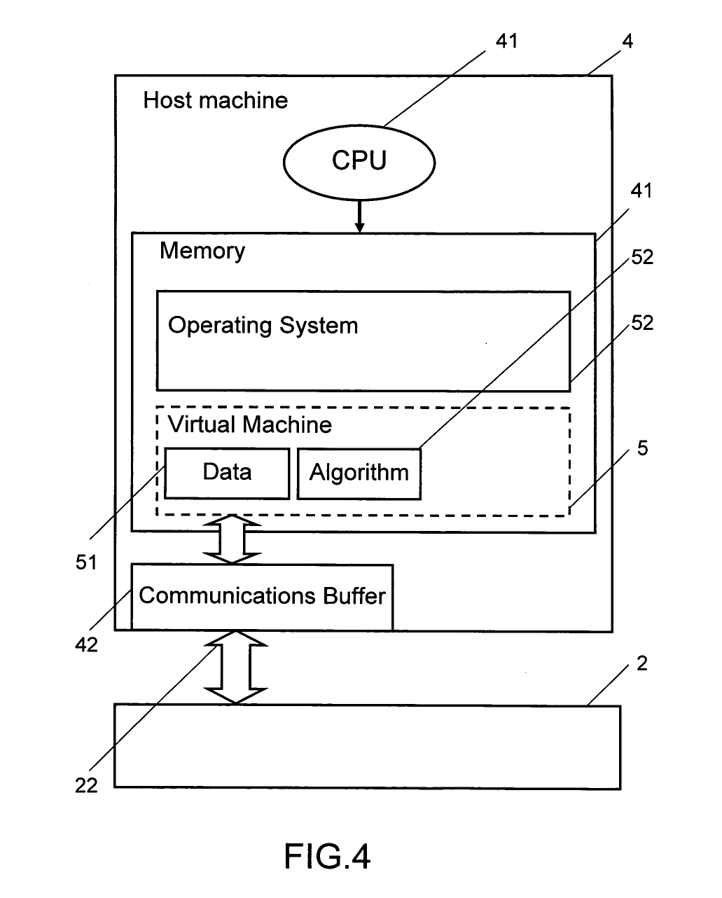

The computer architecture is illustrated in more detail in FIG. 4. A processor 4 comprises a CPU 41, a communication buffer 42 coupling the data distribution network 2 to the processor memory 41. The memory 41 contains the processor operating system 44 and a VM 5 further comprising data 51 and an algorithm 52. The VM is provided as an additional software layer on top of the operating system 44. The data and algorithm enter and processed data leave the VM via a two data communications link 23 to the communications port 22. The invention does not rely on any particular method of transferring data between VM and the computer communications port.

In the preferred embodiment of the invention the VM supports one algorithm assigned to the computer. A VM of this type is commonly referred to as an application virtual machine.

Desirably the VM is designed to be platform-independent, not relying on details of the underlying hardware or operating, allowing a program to execute in the same way on any platform.

The invention does not assume any particular method for configuring algorithms for distributed processing. In one embodiment of the invention the algorithms may comprise sub routines of a computer program. In one embodiment of the invention the algorithms may be identical and designed to allow the computers to perform parallel processing.

The invention is not necessarily restricted to a particular type of VM. Many different types of VM are known to those skilled in the art of computer science. In one embodiment of the invention directed at applications requiring a significant degree of computer user interaction the VM may be configured as a system virtual machine (which is also referred to as a hardware virtual machine). A system virtual machine provides a complete system platform which support execution of a complete operating system. System VMs offer the benefit that multiple operating system environments can co-exist on the same computer in strong isolation from each other. A further benefit of system VMs is that the virtual machine can provide an instruction set architecture (ISA) that is somewhat different from that of the real machine. The advantage of using a system virtual machine is that, firstly greater economy of processing is provide by having more than one process on a single machine and secondly more computationally efficient combinations of algorithms and operating systems may be used

In one embodiment of the invention the VM accesses functions and services provided by the operating system.

Although the VM has been described as an additional software layer on top of the operating system, in certain embodiments of the invention the software layer providing the VM can be run on bare hardware.

In one embodiment of the invention directed at computationally intensive applications a virtual machine may be distributed over more than one computers working in association. However, the distributed portions of the VM may only communicate with each other via the application server. Individual VMs or portions of VMs operating in association would not have network connectivity.

In one embodiment of the invention the VM may request further data for processing from the application server.

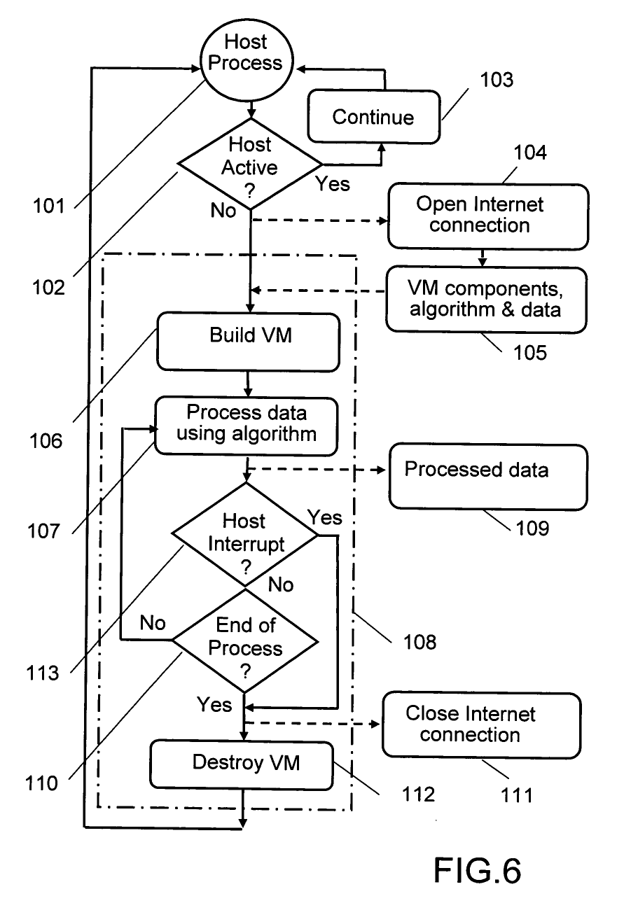

We next consider the process in more with reference to the flow chart of FIG. 6 in which the process steps are indicated by flow chart symbols 101-113. Dashed lines with arrows indicate communications between the computer and the application server. It is assumed that the computer is initially performing a host process indicated by 101. The computer continues processing in its active state as represented by the loop 101,102,103 until it falls into a idle state. The idle state is detected by the application server which proceeds to open the interne connection as indicated by 104. Algorithms including the VM software component sand data are transferred from the server to the computer as indicated by 105. The VM is created within the computer as indicated by 106 and then proceeds to execute a virtual process using the algorithm as indicated by 107 until the end of the process is reached. The VM process is generally indicated by the programming elements enclosed by the dashed and dotted line 108. During the virtual process processed data is transmitted to the server as indicated by 109. At the end of the virtual process as determined at 110 the internet connection is closed as indicated by 111 and the VM is destroyed as indicated by 112. In the event of the host computer becoming active during the virtual process as determined by 113 the virtual process is interrupted. The internet connection closes 111, the VM is destroyed 112 and the computer reverts back to the host process 101.

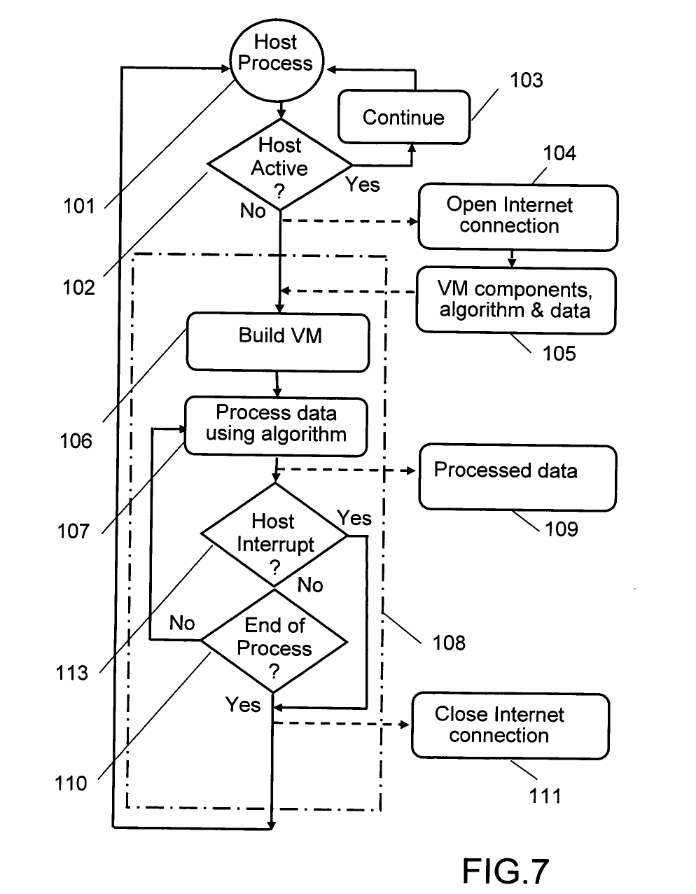

In one embodiment of the invention represented by the flow chart of FIG. 7 the virtual machine is reusable. That is the VM is transmitted to the computer by the application server but retained in the computer when the computer reenters its active state. The VM may be reactivated when the connection to the network is opened following an idle state being detected by the application server. The process is repeated until such time as the processing tasks set by the application server have been completed. Such an embodiment offers the benefit of reducing the time and cost overheads incurred in destroying and re-starting the VM. A reusable virtual machine also avoids the problems of class linking, loading and initialization. Avoiding the creation of a virtual machine environment for each new application also increases the volume and throughput of applications a system can manage. Clearly the process of rebuilding the VM may incur some significant processing overhead. Such problems may be overcome by retaining for subsequent use a copy of all machine values that the machine has set The invention does not rely on any particular method of reusing a VM. Alternative methods are well known to those skilled in the art of software engineering. The flow chart of FIG. 7 is identical to the one of FIG. 6 except that the step of destroying the VM 112 is removed. It will be appreciated from the above description that step 105 will only include providing VM components at the start of the process of building the VM. Thereafter steps 105 will be limited to providing further data.

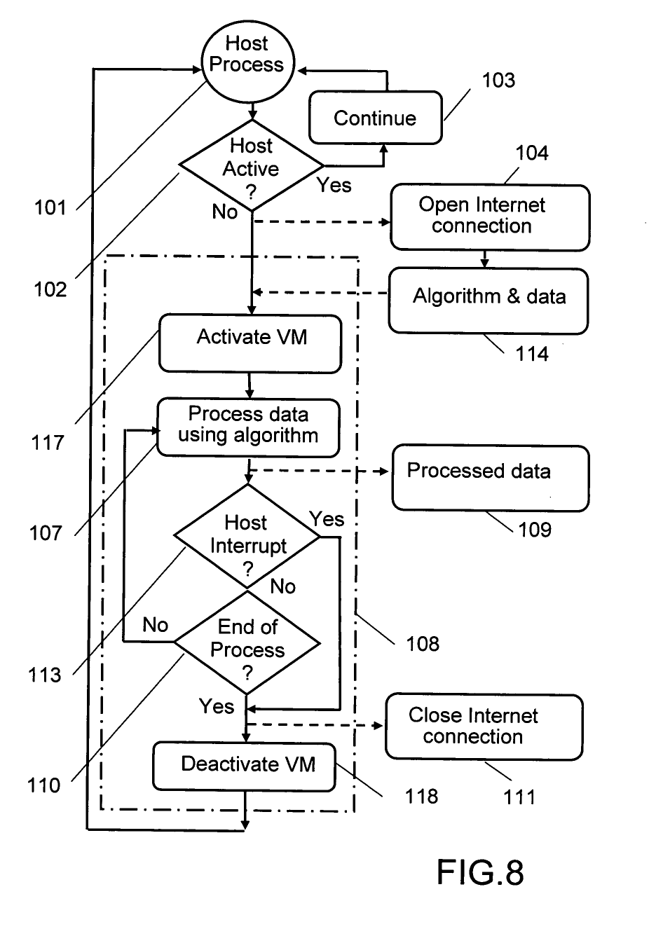

In one embodiment of the invention illustrated in the flow chart of FIG. 8 the VM is encoded within the computer and is dormant while the computer is active. The VM is activated when the connection to the network is opened following an idle state being detected by the application server. The VM is deactivated and the network is closed when the compute re-enters an active state. The process steps are indicated by flow chart symbols 101-118. Dashed lines with arrows indicate communications between the computer and the application server. It is assumed that the computer is initially performing a host process indicated by 101. The computer continues processing in its active state as represented by the loop 101,102,103 until it falls into an idle state. The VM which is integrated within the computer lies dormant at this point. When an idle state is detected by the application server the internet connection is opened as indicated by 104. Algorithms and data are transferred from the application server to the computer as indicated by 114. The VM is activated as indicated by 1117 and then proceeds to execute a virtual process. The VM proceeds to process the data using the algorithm as indicated by 107 until the end of the process is reached. The VM process is generally indicated by the programming elements enclosed by the dashed and dotted line 108. During the virtual process processed data is transmitted to the server as indicated by 109. At the end of the virtual process as determined at 110 the internet connection is closed as indicated by 111 and the VM is deactivated as indicated by 118. In the event of the host computer becoming active during the virtual process as determined by 113 the virtual process is interrupted. The interne connection closes 111, the VM is deactivated 118 and the computer reverts back to the host process 101.

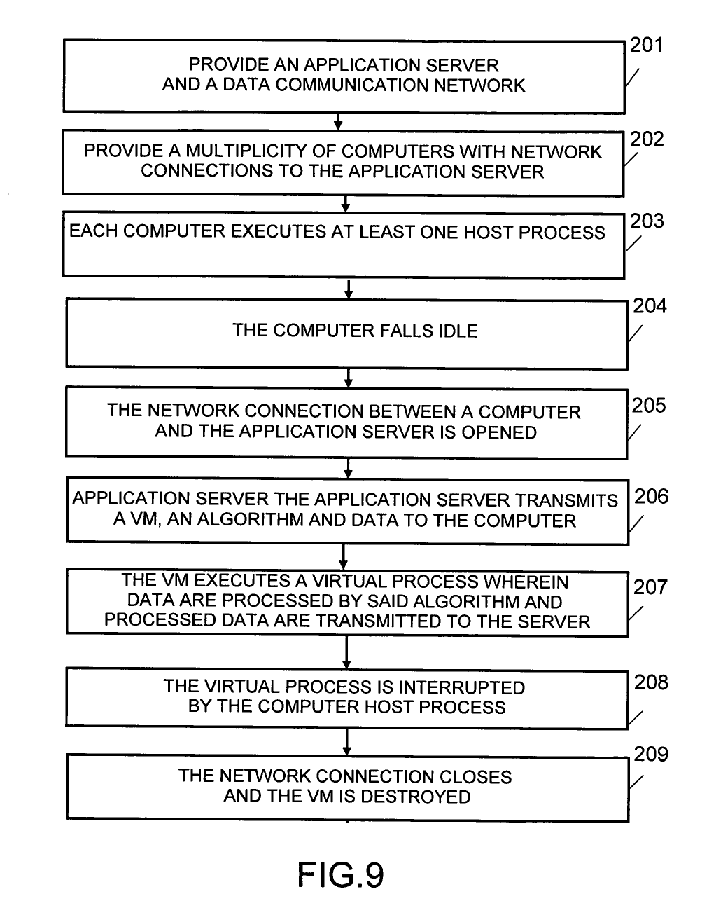

A method of providing distributed processing in accordance with the basic principles of the invention based on the embodiment of FIG. 6 is shown in FIG. 9. Referring to the flow diagram, we see that the said method comprises the following steps:

A method for performing distributed data processing comprising the steps of:

At step 201 providing an application server and a data communication network;

At step 202 providing a multiplicity of computers wherein each said computer has a network connection to said application server;

At step 203 each said computer executes at least one host process;

At step 204 the computer falls idle;

At step 205 the network connection between a computer and the application server is opened;

At step 206 application server the application server transmits a VM, an algorithm and data to the computer;

At step 207 the VM starts to execute a virtual process wherein said data are processed by said algorithm and processed data from said virtual process are transmitted to said server;

At step 208 the virtual process is interrupted by the computer host process;

At step 209 the network connection closes and the VM is destroyed.

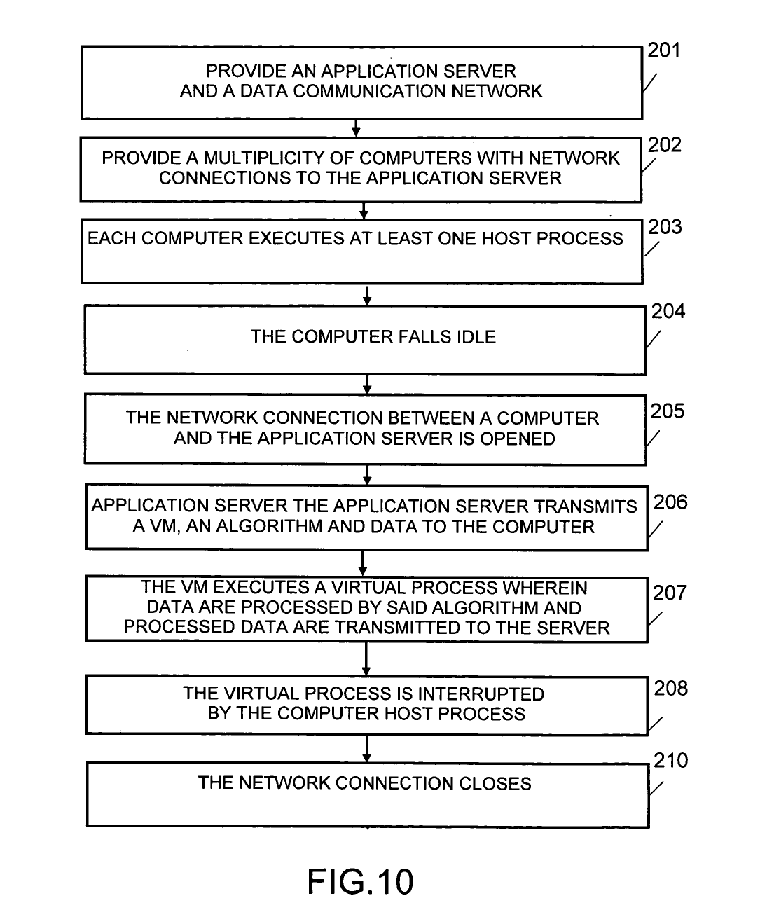

A method of providing distributed processing in which the VM is retained within the computer according to the principles illustrate in FIG. 7 is illustrated by the flow diagram of FIG. 10 which is identical to the flow diagram of FIG. 9 with step 209 being replaced by step 210 in which the network connection closes.

The invention does not rely on any particular application server architecture. In one embodiment of the invention the application server is a computer. In one embodiment of the invention the application server is hybrid human-computing facility wherein humans perform the functions of partitioning computer programs and data for distribution to the computers. In one embodiment of the invention the application server may have links with external database engines.

The invention does not assume any particular type of distributed processing application. The present invention may be used in a range of data processing applications spanning the scientific, business, engineering, financial and other domains.

In one embodiment of the invention the algorithms may algorithms for image processing disclosed in a co-pending British Patent Application No. GB0810737.7 entitled “Hybrid human/computer image processing method” filed on 12 Jun. 2008.

Although the invention is directed at using the resources of a computer that is not running a host process the VM could be designed to provide a limited range of human machine interaction wherein the human intervention, may be provided to varying degrees. In many data processing applications there is requirement for a hybrid human/computing arrangement which advantageously involves humans in the process of scrutinizing data and processing said data to detect and characterize information of interest while ignoring other features of said data. In one embodiment of the present invention the distributed processing system may be used to implement a hybrid information man machine interface such as the one disclosed in patent application British Patent Application No. GB0810737.7 entitled “Hybrid human/computer image processing method” filed on 12 June. The above application is inspired by a hybrid human computer process method called the Mechanical Turk which provides a paradigm for a business method based on using a human workforce to perform tasks in a fashion that is indistinguishable from artificial intelligence. Typically, a computer system decomposes a task into subtasks for human performance. Tasks are dispatched from a command and control centre via a central coordinating server to personal computers operated by a widely distributed workforce. The tasks are referred to as Human Intelligence Tasks or “HITs”. It is proposed that the algorithms and data dispatched to the computers by the application server according to the principles of the present invention could be used provide a HIT according to mechanical Turk principle.

Although the invention has been described in relation to what are presently considered to be the most practical and preferred embodiments, it is to be understood that the invention is not limited to the disclosed arrangements, but rather is intended to cover various modifications and equivalent constructions included within the spirit and scope of the invention without departing from the scope of the following claims.

What is claimed:

1. An apparatus for performing distributed data processing comprising:
an application server; and
a multiplicity of computers,
wherein each computer has a network connection to said application server,
wherein each said computer is operative to execute at least one host process,
wherein said network connection is configured to open when said computer falls idle, characterised in that said application server is operative to transmit a VM, a data processing algorithm and data to said computer on detecting that said computer network connection is open, wherein said VM is operative to execute a virtual process wherein said data are processed by said algorithm and processed data from said virtual process are transmitted to said server,
wherein said network connection is configured to close when said virtual process is interrupted by said host process.

2. The apparatus of claim 1 wherein said application server and said computer are nodes of a data communication network.

3. The apparatus of claim 1 wherein said VM is configured such as to be destroyed when said virtual process is interrupted by said host process.

4. The apparatus of claim 2 wherein said data communication network is the Internet.

5. The apparatus of claim 1 wherein said virtual machine provides a virtual graphical user interface.

6. The apparatus of claim 1 wherein two or more computers exchange processed data.

7. The apparatus of claim 1 wherein identical algorithms are distributed to said computers.

8. The apparatus of claim 1 wherein said computers perform parallel processing of said data.

9. The apparatus of claim 1 wherein said VM is configured to use at least a subset of the resources of said computer.

10. A method for performing distributed data processing comprising the steps of:
(a) providing an application server;
(b) providing a data communication network;
(c) providing a multiplicity of computers wherein each said computer executes at least one host process and each said computer has a network connection to said application server;
(d) opening said network connection when said computer falls idle;
(e) on detecting that said computer network connection is open said application server transmitting a VM, an algorithm and data to said computer;
(f) said VM executing a virtual process wherein said data are processed by said algorithm and processed data from said virtual process are transmitted to said server;
(g) said network connection closing when said computer virtual process is interrupted by said host process.

11. The method of claim 10 wherein said application server and said computer are nodes of a data communication network.

12. The method of claim 10 wherein said VM is configured such as to be destroyed when said virtual process is interrupted by said host process.

13. The method of claim 11 wherein said data communication network is the Internet.

14. The method of claim 10 wherein said virtual machine provides a virtual graphical user interface.

15. The method of claim 10 wherein two or more computers exchange processed data.

16. The method of claim 10 wherein identical algorithms are distributed to said computers.

17. The method of claim 10 wherein said computers perform parallel processing of said data.

18. The method of claim 10 wherein said VM is configured to use at least a subset of the resources of said computer.
